(19) United States
(12) Patent Application Publication
(10) Pub. No.: US 2013/0120461 A1
(43) Pub. Date: May 16, 2013

(54) IMAGE PROCESSOR AND IMAGE PROCESSING METHOD

(71) Applicants: Yukie Takahashi, Tokyo (JP); Kei Imada, Tokyo (JP)

(72) Inventors: Yukie Takahashi, Tokyo (JP); Kei Imada, Tokyo (JP)

(21) Appl. No.: 13/558,133

(22) Filed: Jul. 25, 2012

(30) Foreign Application Priority Data
Nov. 14, 2011 (JP) 2011-249177

(51) Int. Cl. G09G 5/00

(52) U.S. Cl. 345/660

(57) ABSTRACT

According to one embodiment, an image processing method includes: generating reduced information obtained by reducing input image information with a reduction ratio; calculating a moving amount in a unit of a first display area based on the reduced information and reduced previous information obtained by reducing image information input prior to the input image information with the reduction ratio; calculating a moving amount in a unit of a second display area of the input image information by magnifying the moving amount in the unit of a first display area calculated with a first magnification ratio that is an inverse of the reduction ratio, and calculate an adjustment level in the unit of the second display area based on the moving amount in the unit of the second display area, which indicates a level of high frequency component image information to be blended on the input image information.

### CROSS-REFERENCE TO RELATED APPLICATIONS

This application is based upon and claims the benefit of priority from Japanese Patent Application No. 2011-249177, filed on Nov. 14, 2011, the entire contents of which are incorporated herein by reference.

### FIELD

Embodiments described herein relate generally to an image processor and an image processing method.

### BACKGROUND

Cameras and television receivers perform various types of image processing to improve the resolution and quality of images. A technique for adding high frequency image components such as textures on frame images is one of the image processing. In this technique, a texture image is generated for each frame image and added on a high frequency component image, for example. As a result, the texture quality of the image can be improved.

In the technique, however, an analysis, etc., performed for adding a high frequency image such as a texture on each frame image involves large processing load.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram illustrating a structure of an image processor according to a first embodiment;

FIG. 2 is an exemplary schematic diagram illustrating a distribution calculator in the embodiment;

FIG. 3 is an exemplary schematic diagram explaining a probability distribution in the embodiment;

FIG. 4 is an exemplary schematic diagram illustrating image processing in the image processor in the embodiment;

FIG. 5 is an exemplary schematic diagram illustrating output image data in which blend is made by using an image quality adjustment coefficient calculated based on a unit of 64×64 dots;

FIG. 6 is an exemplary schematic diagram illustrating interpolation of the image quality adjustment coefficient by a coefficient interpolator in the embodiment;

FIG. 7 is an exemplary schematic diagram illustrating a reference area used for calculating the image quality adjustment coefficient based on a unit of 8×8 dots by the coefficient interpolator in the embodiment;

FIG. 8 is an exemplary schematic diagram illustrating output image data in which blend is made by using the image quality adjustment coefficient interpolated based on the unit of 8×8 dots; and

FIG. 9 is an exemplary flowchart illustrating a procedure of processing to generate the output image data in the image processor in the embodiment.

### DETAILED DESCRIPTION

In general, according to one embodiment, an image processor comprises: an image reducer configured to generate reduced input image information obtained by reducing input image information indicating input image information with a predetermined reduction ratio; a moving amount calculator configured to calculate a moving amount in a unit of a predetermined first display area based on the reduced input image information and reduced previous image information obtained by reducing image information input prior to the input image information with the predetermined reduction ratio; a calculator configured to calculate a moving amount in a unit of a second display area of the input image information by magnifying the moving amount in the unit of a predetermined first display area calculated by the moving amount calculator with a first magnification ratio that is an inverse of the predetermined reduction ratio, and calculate an adjustment level in the unit of the second display area based on the moving amount in the unit of the second display area, the adjustment level indicating a level of high frequency component image information to be blended on the input image information; and a blending module configured to blend the high frequency component image information on the input image information in accordance with the adjustment level calculated by the calculator.

### First Embodiment

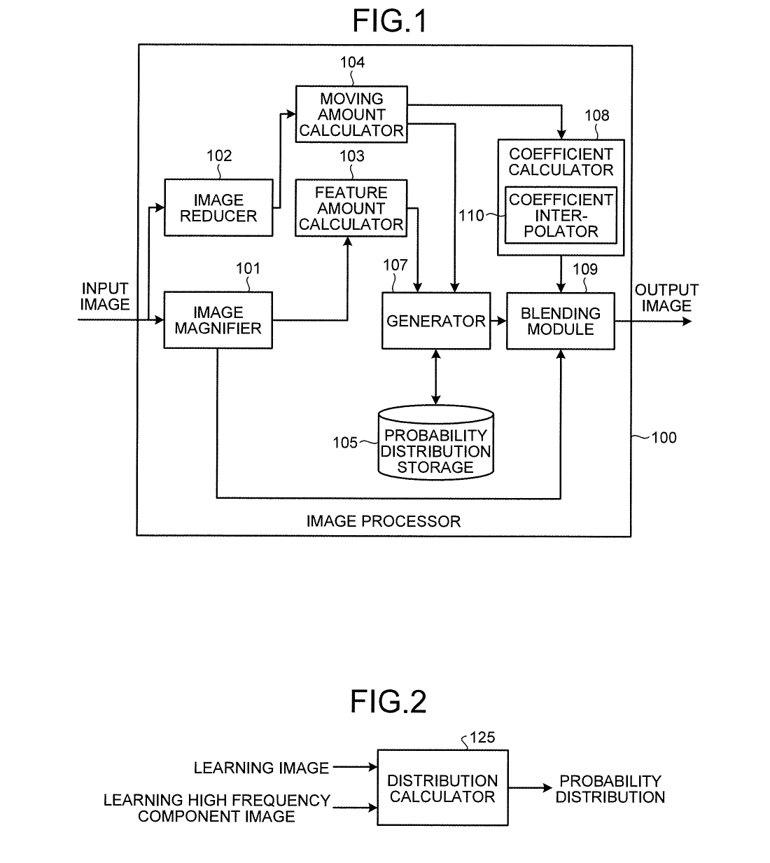

FIG. 1 is a block diagram illustrating an exemplary structure of an image processor according to a first embodiment. As exemplarily illustrated in FIG. 1, an image processor 100 comprises an image magnifier 101, an image reducer 102, a characteristic amount calculator 103, a moving amount calculator 104, a probability distribution storage 105, a generator 107, a coefficient calculator 108, and a blending module 109. The image processor 100 is included in a camera and a television receiver, for example. The image processor 100 performs various types of image processing on input image data and thereafter outputs the resulting data as output image data.

The image magnifier 101 magnifies the input image data with a predetermined magnification ratio to generate magnified input image data. The image magnifier 101 according to the embodiment magnifies the input image data of full high definition (HD) (1920×1080 dots) to generate the magnified input image data of 4K2K (3840×2160 dots), for example. The magnification ratio according to the embodiment is two in both of the vertical direction and the horizontal direction, for example. In the embodiment, the image sizes of the input image data and the magnified input image data are not limited to specific sizes. For example, the input image data of standard definition (SD) may be magnified to the magnified input image data of HD.

Any image magnifying technique such as nearest neighbor interpolation, linear interpolation, or cubic convolution can be used by the image magnifier 101. Many image data magnification techniques have been proposed that magnify images by interpolating pixel values such as above techniques. It is recommended to use a technique that can obtain images having blurring as little as possible. The image quality of the image data may be deteriorated by being magnified by the image magnifier 101. The image quality of the input image data may be deteriorated due to imaging, compression, magnification, or reduction performed on the input image data before being received. In the embodiment, the deterioration of image quality after being magnified is suppressed by a structure described later.

The image reducer 102 reduces the input image data with a predetermined reduction ratio to generate a reduced input image. The image reducer 102 according to the embodiment reduces the input image data of full high definition (HD) (1920×1080 dots) to reduced input image data (480×270 dots), for example. The reduction ratio according to the embodiment is one-fourth in both of the vertical direction and the horizontal direction, for example. In the embodiment, processing load can be reduced by obtaining a moving amount, which is described later, based on the reduced input image data. In the embodiment, the image size and the reduction ratio of the reduced input image data are not limited to specific sizes and ratios. As a modified example, gradient characteristic data and the moving amount may be calculated based on the input image data without reducing the input image data.

Algorithms such as bi-linear and bi-cubic may be used by the image reducer 102 as a technique for reducing the input image data. The reduction technique, however, is not limited to these algorithms. In the embodiment, the processing load can be reduced by processing, which is described later, performed after the reduction processing by the image reducer 102.

The characteristic amount calculator 103 calculates the gradient characteristic data for each pixel included in the magnified input image data. The gradient characteristic data is characteristic information that represents a change in pixel values in a predetermined display area surrounding each pixel included in the magnified input image data as a gradient. For example, the characteristic amount calculator 103 calculates the gradient characteristic data for each pixel included in the magnified input image data by using a differential filter, for example. In the embodiment, the characteristic amount calculator 103 calculates the gradient characteristic data in the horizontal direction by using a horizontal direction differential filter and the gradient characteristic data in the vertical direction by using a vertical direction differential filter for each pixel. The size of the filter used for the calculation is from 3×3 to 5×5, for example. The size, however, is not limited to specific sizes. In the following description, the gradient characteristic in the horizontal direction may be described as “Fx” while the gradient characteristic in the vertical direction may be described as “Fy”. In the embodiment, the gradient characteristic data is used as the characteristic data of each pixel. The characteristic data, however, is not limited to the gradient characteristic data. Any characteristic data that can indicate the difference between pixels can be used.

The moving amount calculator 104 calculates a moving amount based on a predetermined display area size unit by using the reduced input image data (a backward frame) and reduced previous image data (a forward frame) obtained by reducing the image data input before the input of the input image data. The moving amount calculator 104 according to the embodiment calculates the moving amount based on the unit of 8×8 bits as the predetermined display area size unit. Other display area size maybe used as the unit. The moving amount may be calculated based on a pixel or a sub-pixel, which is smaller than the pixel, as the unit. The reduced input image data of the forward and backward frames included in moving image data is used as the image data by which the moving amount is calculated, for example. The moving amount calculator 104 calculates a motion vector that is a change amount of movement from a pixel of the reduced input image data serving as an image processing target to a pixel of the reduced input image data having been processed just before the image processing. Then, the moving amount calculator 104 calculates the moving amount for each pixel from the motion vector as an absolute value.

The generator 107 calculates a gradient intensity of a local gradient pattern by using a probability distribution and the calculated gradient characteristic data (Fx and Fy). The gradient intensity is a weight relating to a high frequency component of each pixel included in the magnified input image data. The probability distribution represents a distribution of a relative value of the gradient characteristic data of the high frequency component of the pixel included in learning image data to the gradient characteristic data of the pixel included in the learning image data.

The local gradient pattern according to the embodiment is a predetermined image pattern that represents a change pattern of a predetermined pixel value (e.g., luminance value). The gradient intensity is the weight relating to the high frequency component of each pixel included in the magnified input image data and calculated by using the gradient characteristic. The gradient intensity is used for generating the high frequency component of the magnified input image data.

The generator 107 weighs the local gradient pattern with the gradient intensity to generate texture image data that indicates the high frequency component of the magnified input image data. The details of the local gradient pattern and the gradient intensity are described later.

The probability distribution according to the embodiment, which is the distribution of the relative value as described above, represents the distribution of a relative angle and a relative magnitude of the gradient of the pixel of learning high frequency component image data to the gradient of each pixel in the learning image data. The probability distribution is described below. FIG. 2 is a schematic diagram illustrating a distribution calculator 125 according to the embodiment. The distribution calculator 125 may be included in the image processor 100. The distribution calculator 125 may be installed outside the image processor 100 and the probability distribution calculated by the distribution calculator 125 may be stored in the image processor 100.

As illustrated in FIG. 2, the distribution calculator 125 receives the learning image data and the learning high frequency component image data and outputs probability distribution data. The output probability distribution data is stored in the probability distribution storage 105.

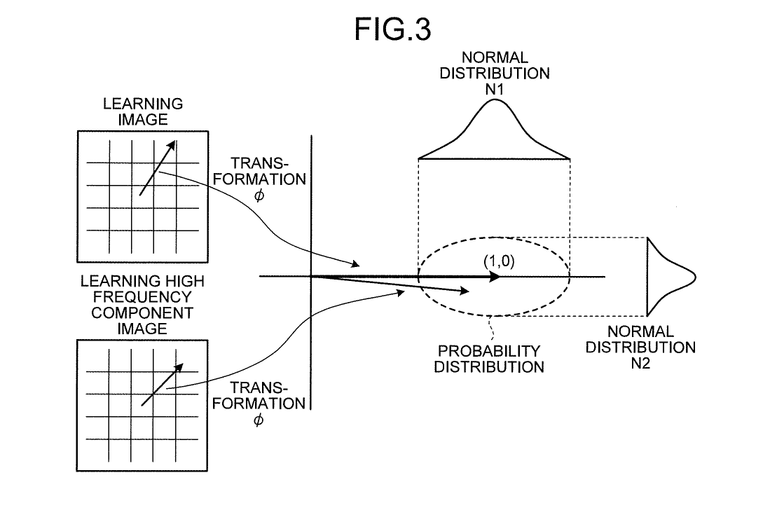

FIG. 3 is a schematic diagram explaining the probability distribution according to the embodiment. The distribution calculator 125 calculates the gradients of the pixels each of which is located at the same position in the learning image data and the learning high frequency component image data. The differential filter used for calculating the gradients is the same as that used by the characteristic amount calculator 103. The learning high frequency component image data is the image data of the high frequency component of the learning image data. The image quality of the learning image data may be deteriorated in the same manner as the magnified input image data.

As illustrated in FIG. 3, the distribution calculator 125 calculates the probability distribution on an area of a two-dimensional plane. The x axis of the plane area is defined as a gradient direction of the pixel of the learning data while the y axis is defined as the direction perpendicular to the gradient direction. The distribution calculator 125 transforms the gradient of the pixel of the learning image data into a vector (1,0) for each pixel. A transformation matrix that transforms the gradient of a predetermined pixel of the learning image data into the vector (1,0) is defined as “transformation φ”. The distribution calculator 125 transforms the gradient of the pixel of the learning high frequency component image data located at the same position as the predetermined pixel of the learning image data by using the transformation φ. As a result, the vector of the gradient of each pixel of the learning high frequency component image data is obtained by being relatively transformed based on the gradient of the pixel of the learning image data.

The distribution calculator 125 calculates the vector of the gradient of the high frequency component for each pixel as described above. As a result, the distribution calculator 125 calculates the probability distribution indicated with the dashed line in FIG. 3. The probability distribution represents the variation of the gradient of the learning high frequency component image data. As illustrated in FIG. 3, the probability distribution is expressed by two-dimensional normal distributions, i.e., a “normal distribution N1” and a “normal distribution N2”.

The image processor 100 according to the embodiment preliminarily stores the probability distribution calculated by the processing described above in the probability distribution storage 105.

The generator 107 calculates the gradient intensity by using the probability distribution and the gradient characteristic data. Let the average of the “normal distribution N1” be “μ1” and a standard deviation of the “normal distribution N1” be “σ1”. Let the average of the “normal distribution N2” be “μ2” and the standard deviation of the “normal distribution N2” be “σ2”. The generator 107 acquires a random variable “α” from the “normal distribution N1” and a random variable “β” from the “normal distribution N2”. The generator 107 calculates the gradient intensity of the high frequency component by substituting the random variables “α” and “β” and the gradient characteristic data (Fx and Fy) into formula (1).

fx=αFx+βFy fy=βFy−βFx (1)

In formula (1), “fx” is the gradient intensity in the horizontal direction while “fy” is the gradient intensity in the vertical direction.

Then, the generator 107 generates the high frequency component of the input image data by using the gradient intensities of the high frequency component (fx in the horizontal direction and fy in the vertical direction) and the local gradient patterns (Gx in the horizontal direction and Gy in the vertical direction). “Gx” and “Gy” are predetermined image patterns that represent change patterns of predetermined pixel values. In the embodiment, these patterns are base patterns having the same luminance change as the filter used for calculating the gradients of the learning high frequency component image by the distribution calculator 125.

That is, the generator 107 calculates a high frequency component “T” by substituting the gradient intensities (fx in the horizontal direction and fy in the vertical direction) and the local gradient patterns (Gx in the horizontal direction and Gy in the vertical direction) into formula (2) for each pixel included in the magnified input image data. The -high frequency component image data including the high frequency component “T” calculated for each pixel is used as the texture image data in the embodiment. In the embodiment, the texture image data has the same display area size as the magnified input image data.

T=fx•Gx+fy•Gy (2)

Then, the generator 107 obtains the gradient intensity of the high frequency component by using the probability distribution that represents the distribution of the vector indicating the relative angle and magnitude of the gradient of the learning high frequency component image to the gradient of the learning image, and the gradient characteristic calculated by the characteristic amount calculator 103.

When generating the high frequency component of the magnified input image data input next, the generator 107 generates the high frequency component by using the moving amount between the previously input magnified input image data and the magnified input image data input next. In the embodiment, the image data (reduced input image data) used for searching the moving amount and the magnified input image data have different display area sizes from each other. Because of the difference, the generator 107 according to the embodiment expands the moving amount so as to fit the display area size of the magnified input image data. The generator 107 according to the embodiment calculates the moving amount of the magnified input image data (eight times the reduced input image data in both the vertical and the horizontal directions) based on the unit of 64×64 dots from the moving amount of the reduced input image data calculated by the moving amount calculator 104 based on the unit of 8×8 dots.

In the embodiment, the moving amount of the magnified input image data is calculated by using the moving amount calculated based on the reduced input image data as described above. The embodiment, however, does not limit the manner for calculating the moving amount of the magnified input image data. For example, there is a case where the image processor does not magnify input image data and outputs it as the output image data. In such a case, the generator, which calculates the moving amount of the input image data by using the moving amount calculated based on the reduced input image data, may calculate the moving amount based on the unit of 32×32 dots from the moving amount of the reduced input image data calculated by the moving amount calculator based on the unit of 8×8 dots. The calculation unit, 32×32 dots, is four times (the inverse of the reduction rate of ¼) the calculation unit, 8×8 dots, in both the vertical and the horizontal directions.

The generator 107 acquires the random variables of the pixel of the magnified input image data based on the motion vector calculated by the moving amount calculator 104. The generator 107 according to the embodiment specifies the position of the pixel of the magnified input image data before being moved based on the calculated motion vector and acquires the random variables at the specified position from the probability distribution storage 105. For example, the generator 107 acquires the random variables “α” and “β” from a memory area of the probability distribution storage 105, corresponding to the coordinate position of the immediate-previously processed magnified input image data indicated by the motion vector calculated by the moving amount calculator 104. For example, when the motion vector indicates the coordinates (i, j) in the current magnified input image data and the coordinates (k, l) in the previously magnified input image data, and the memory area of the probability distribution storage 105 is “M×N”, the generator 107 acquires the random variables of the coordinates (i, j) from the position (k mod M, l mod N) of the probability distribution storage 105. Regarding the position, “k mod M” represents the remainder of “k” divided by “M” while “l mod N” represents the remainder of “l” divided by “N”.

According to the embodiment, which random variables have been used for the previous input image can be found. The memory area, which corresponds to the coordinates indicated by the motion vector in the previously processed input image, of the probability distribution storage 105 is used as described above. As a result, flickering can be suppressed when moving images are processed.

The generator 107 calculates the gradient intensity of the high frequency component of the pixel that is included in the magnified input image data and has been moved from the previously magnified input image data, for each pixel, by substituting the acquired random variables “α” and “β” and the gradient characteristics (Fx and Fy) calculated by the characteristic amount calculator 103 into formula (1).

Then, the generator 107 calculates the high frequency component “T” for each pixel included in the magnified input image data by substituting the calculated gradient intensities (fx in the horizontal direction and fy in the vertical direction) of the high frequency component and the local gradient patterns (Gx in the horizontal direction and Gy in the vertical direction) into formula (2). The high frequency component image data including the high frequency component “T” calculated for each pixel is used as the texture image data in the embodiment. In the embodiment, the texture image data has the same display area size as the magnified input image data.

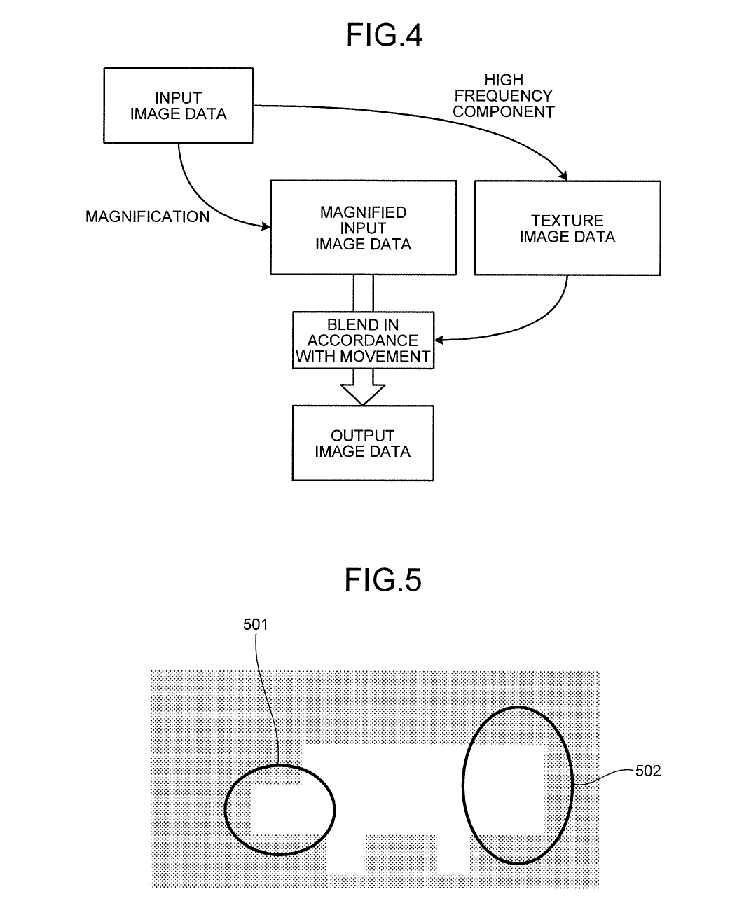

FIG. 4 is a schematic diagram explaining image processing in the image processor 100 according to the embodiment. As illustrated in FIG. 4, the image processor 100 generates the magnified input image data and the texture image data from the input image data, blends the texture image data on the magnified input image in accordance with the detected amount of movement (moving amount), and generates the output image data.

When the image data of HD is simply magnified to the image data of 4K2K, the magnified image data provides a blurring image having weak texture. In contrast, the texture image data is composed of the high frequency components as described above. Therefore, when the image processor 100 displays the output image data generated by superimposing the texture image data on a display, the textures can be finely displayed. As a result, high quality image can be achieved by the improved texture.

When the texture image data is simply blended on the magnified input image data, minute patterns are emphasized in the display area displaying movements, for example. The emphasized patterns cause a user to perceive them as noises.

The image processor 100 according to the embodiment calculates a level of the texture image data to be blended (hereinafter, referred to as an image quality adjustment coefficient) in accordance with the moving amount obtained by motion search by the moving amount calculator 104, and blends the texture image data on the magnified input image data by using the calculated image quality adjustment coefficient.

The coefficient calculator 108 calculates the image quality adjustment coefficient of the texture image data that is to be blended on the magnified input image data based on the unit of 64×64 dots in accordance with the moving amount calculated by the moving amount calculator 104.

In the embodiment, the moving amount calculator 104 performs the motion search on the reduced input image data based on the unit of 8×8 dots. The reduced input image data is obtained by reducing the input image date by the reduction ratio of one-quarter in both the vertical and the horizontal directions. In order to magnify the moving amount so as to have the same resolution as the input image data, the coefficient calculator 108 magnifies the unit of 8×8 dots by four times (the inverse of the reduction ratio of one-quarter) in both the vertical and the horizontal directions, and obtains the moving amount of the input image data based on the unit of 32×32 dots. The coefficient calculator 108 further magnifies the unit of 32×32 dots by two times in both the vertical and the horizontal directions in order to magnify the moving amount so as to have the same resolution as the magnified input image data, and obtains the moving amount of the magnified input image data based on the unit of 64×64 dots.

The coefficient calculator 108 calculates the image quality adjustment coefficient based on the unit of 64×64 dots in accordance with the moving amount based on the unit of 64×64 dots. The coefficient calculator 108 according to the embodiment calculates the image quality adjustment coefficient with a range from 0.0 to 1.0 in accordance with the moving amount. For example, when the detected moving amount exceeds a predetermined upper limit value, the coefficient calculator 108 determines the image quality adjustment coefficient as “0.0” while, when the detected moving amount is below a predetermined lower limit value, the coefficient calculator 108 determines the image quality adjustment coefficient as “1.0”.

In the calculation method of the image quality adjustment coefficient according to the embodiment, the larger an image quality adjustment coefficient a the smaller the moving amount and the smaller the image quality adjustment coefficient a the larger the moving amount. The calculation method, however, is not limited to the manner described above. Any method that can appropriately set the image quality adjustment coefficient in accordance with the moving amount can be employed. Alternatively, the image quality adjustment coefficient may be calculated by combining other variables in addition to the moving amount.

FIG. 5 is a schematic diagram illustrating an example of the output image data which is blended by using the image quality adjustment coefficient calculated based on the unit of 64×64 dots. As illustrated in areas 501 and 502 of FIG. 5, the boarder between the display area in which no texture image data is blended and the display area in which the texture image data is blended is obviously perceived, when whether the texture image data is blended is determined in accordance with the calculation results based on the unit of 64×64 dots of the coefficient calculator 108. Therefore, in the image processor 100 according to the embodiment, a coefficient interpolator 110 interpolates the image quality adjustment coefficient.

The coefficient interpolator 110 calculates the image quality adjustment coefficient based on the unit of 8×8 dots included in an arbitrary display area by using the image quality adjustment coefficient of the arbitrary display area represented by the unit of 64×64 dots and the image quality adjustment coefficients of display areas each represented by the unit of 64×64 dots adjacent to the arbitrary display area.

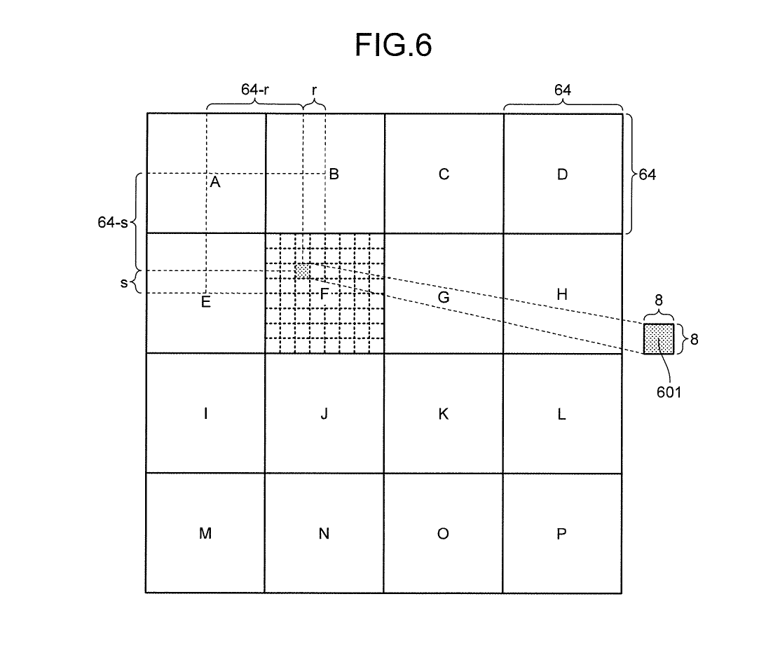

FIG. 6 is a schematic diagram illustrating an example of interpolation of the image quality adjustment coefficient by the coefficient interpolator 110. In the example illustrated in FIG. 6, the coefficient interpolator 110 obtains the image quality adjustment coefficient based on a block unit, which includes 8×8 dots obtained by dividing the display area of 64×64 dots, by using the image quality adjustment coefficients of display areas “A” to “P”. The image quality adjustment coefficients of display areas “A” to “P” are calculated based on the unit of 64×64 dots. The coefficient interpolator 110 calculates the image quality adjustment coefficient based on the unit of 8×8 dots for each block, which includes 8×8 dots and is obtained by dividing the display area, by using weights (e.g., r/64 and s/64) corresponding to distances (r and s) to 64×64 dot display areas adjacent to the display area, and the image quality adjustment coefficients of the adjacent display areas. The coefficient interpolator 110 calculates an image quality adjustment coefficient vrng of a block 601 located on the upper left in a display area F by using formula (3).

vrng={a×(r/64)+b×[(64−r)/64]}×(s/64)+{e×(r/64+f×[(64−r)/64]}×[(64−s)/64] (3)

where a, b, e, and f are the image quality adjustment coefficients of the display areas A, B, E, and F, respectively, and the distances (s and r) indicate the distances from the center of the display area F.

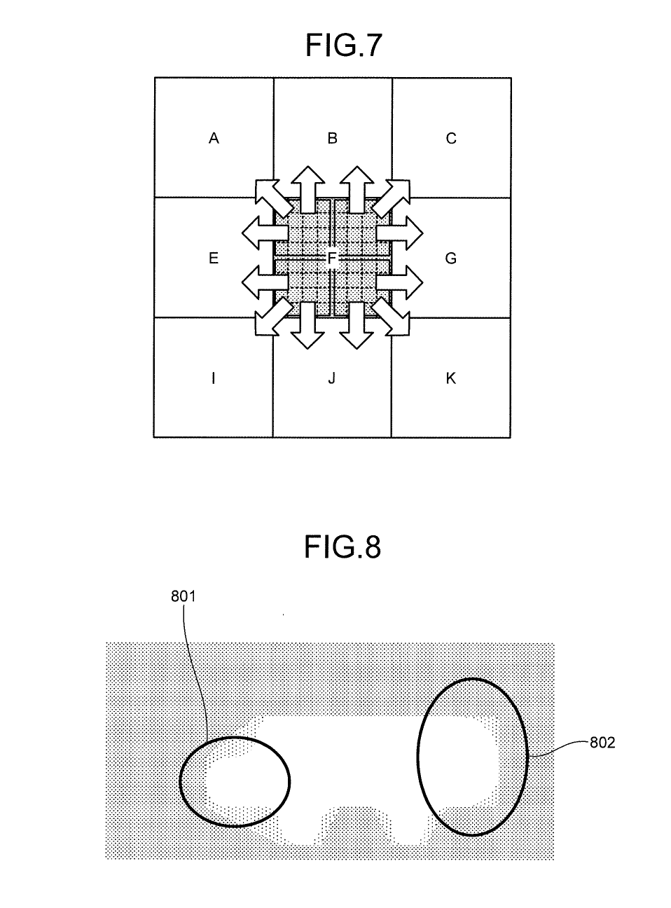

FIG. 7 is a schematic diagram illustrating an example of reference areas used for calculating the image quality adjustment coefficient based on the unit of 8×8 dots by the coefficient interpolator 110. As illustrated in FIG. 7, when calculating the image quality adjustment coefficient based on the unit of 8×8 dots for blocks in the display area F, the coefficient interpolator 110 uses the display areas A, B, and E for the blocks located at the upper left in the display area F, the display areas B, C, and G for the blocks located at the upper right in the display area F, the display areas E, I, and J for the blocks located at the lower left in the display area F, and the display areas G, J, and K for the blocks located at the lower right in the display area F.

FIG. 8 is a schematic diagram illustrating an example of the output image data which is blended by using the image quality adjustment coefficient interpolated based on the unit of 8×8 dots. As illustrated in areas 801 and 802 of FIG. 8, the border between the display area in which no texture image data is blended and the area in which the texture image data is blended is blurry and smoothened when the image quality adjustment coefficient based on the unit of 8×8 dots is used.

In the embodiment, the image quality adjustment coefficient is interpolated based on the unit of 8×8 dots. The unit used for interpolation is not limited to 8×8 dots. For example, the image quality adjustment coefficient may be interpolated based on 4×4 dots or a pixel as the unit.

The blending module 109 blends the texture image data on the magnified input image data by using the image quality adjustment coefficient calculated by the coefficient calculator 108. The blending module 109 according to the embodiment blends the texture image data on the magnified input image data based on the unit of 8×8 dots by using the image quality adjustment coefficient calculated based on the unit of 8×8 dots. Asa result, the output image data having the same image size as the magnified input image data is generated.

The blending module 109 according to the embodiment calculates the output image data by performing a process expressed by formula (4) for each pixel.

Z=X+αY (4)

where Z is the pixel value of the output image data, X is the pixel value of the magnified input image data, Y is the pixel value of the texture image data, and a is the image quality adjustment coefficient. The pixel values X, Y, and Z are the pixel values of the pixels each located on the same position in the respective data.

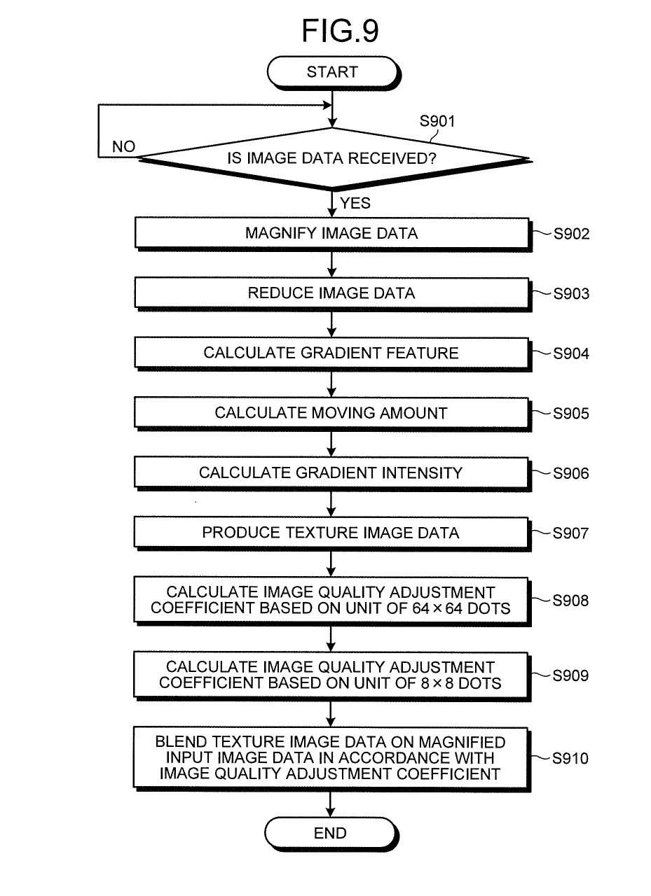

Processing to generate the output image data in the image processor 100 according to the embodiment is described below. FIG. 9 is a flowchart illustrating a procedure of the processing in the image processor 100 according to the embodiment.

In the example illustrated in FIG. 9, the image magnifier 101 determines whether the image processor 100 receives input image data. If the image magnifier 101 determines that the image processor 100 receives the input image data (Yes at S901), the image magnifier 101 magnifies the input image data by using any image magnification method with a predetermined magnification ratio to generate a magnified input image (S902). If the image magnifier 101 determines that the image processor 100 does not receive the input image data (No at S901), the image magnifier 101 waits receiving input image data.

When the input image data is received, the image reducer 102 reduces the input image data by using any image reduction method with a predetermined reduction ratio and generates the reduced input image data (S903).

The characteristic amount calculator 103 calculates the gradient characteristic in the horizontal direction by using the horizontal direction differential filter and the gradient characteristic in the vertical direction by using the vertical direction differential filter for each pixel of the magnified input image data (S904).

The moving amount calculator 104 calculates the moving amount and the motion vector that represent the movement from the pixel in the previously processed reduced input image data to the pixel in the reduced input image data serving as the image processing target based on the unit of 8×8 dots (S905).

The generator 107 obtains the gradient intensity of the pixel of the magnified input image data by using the random variables based on the probability distribution and the gradient characteristics calculated by the characteristic amount calculator 103 for each pixel. The probability distribution represents the distribution of the vector indicating the relative angle and magnitude of the gradient characteristic of the pixel included in the high frequency component of the learning image data to the gradient characteristic of the pixel included in the learning image data (S906).

Then, the generator 107 generates the texture image data representing the high frequency component of the magnified input image data by using the gradient intensity of the high frequency component of each pixel of the magnified input image data and the local gradient patterns (S907).

The coefficient calculator 108 calculates the image quality adjustment coefficient based on the unit of 64×64 dots in accordance with the moving amount based on the unit of 64×64 dots, which the unit is magnified so as to fit the display area size of the magnified input image data (S908).

The coefficient interpolator 110 calculates the image quality adjustment coefficient based on the unit of 8×8 dots by using the image quality adjustment coefficient based on the unit of 64×64 dots and the image quality adjustment coefficients of the adjacent reference areas represented by the unit of 64×64 dots (S909).

The blending module 109 blends the texture image data on the magnified input image data by using the image quality adjustment coefficient based on the unit of 8×8 dots and generates the output image data (S910).

The image processor 100 according to the embodiment can output the output image data representing sharp and natural images by the above-described processing. The embodiment does not limit the sequence of the processing to the processing procedure illustrated in FIG. 8. For example, S902 and S903 may be interchanged. As another example, S904 and S905 may be interchanged.

In the image processor 100 according to the embodiment, the gradient characteristics are calculated by using the horizontal direction differential filter for the x-axis direction and the vertical direction differential filter for the y-axis direction. Any characteristics that can be extracted by the filters and another filter may be used.

In the image processor 100 according to the embodiment, the memory area corresponding to the coordinates of the previously magnified input image data before being moved with the moving amount is used to acquire the random variables of each pixel in the magnified input image data serving as the image processing target. As a result, flickering in moving images can be prevented when movements occur between the input image data. In the conventional processing, the random variables are independently obtained for each frame and used. Values used for computation relating to image processing may differ in each frame. This difference may cause flickering to occur in moving images due to the difference in image processing results of the frames. In contrast, the image processor 100 according to the embodiment can prevent flickering in moving images.

The image processor 100 according to the embodiment can generate the output image data representing sharp and natural images in the following manner. The image processor 100 generates the texture image data, which is the high frequency component of the magnified input image data, by using the characteristic amounts of the pixels of the magnified input image data image quality of which has been deteriorated due to magnifying the input image data, and the probability distribution representing the distribution of the relative vector of the learning image including the high frequency component to the learning image data image quality of which has been deteriorated, and blends the texture image data on the magnified input image data. The image processor 100 suppresses flickering in the output image data by using the image quality adjustment coefficient in the superimposition so as to decrease the emphasis level by the texture image data on an area having a large moving amount.

The image processor 100 according to the embodiment performs smoothing by interpolating the image quality adjustment coefficient calculated based on a magnitude of movement (moving amount) without using the motion vector. As a result, control faithfully based on the magnitude of the movement can be achieved regardless of a temporal direction. In addition, flickering in an area including the high frequency component, such as the texture, can be suppressed.

Generally, the conventional motion search and high resolution processing require a huge amount of computation. Because of the huge computation amount, it is difficult to process in real time a target image frame having a large data size, such as full HD or 4K2K. In contrast, the image processor 100 according to the embodiment can drastically reduce the computation amount because the image processor 100 calculates the moving amount of the pixel by using the reduced input image data obtained by reducing the input image data and adjusts the image quality for high resolution processing based on the calculated moving amount.

The motion search is often performed on a block basis, such as a block composed of 8×8 dots, instead of performing on a pixel basis in order to reduce the processing load. When the motion research is performed by using the reduced input image data and the image quality adjustment coefficient is generated by applying the search result to the output image data, the display area, which corresponds to the block of the reduced input image data, of the output image data is increased in proportion to the reduction ratio. As a result, the image quality of the output image data deteriorates. Because the difference between display areas adjacent to each other is obviously perceived and the block shape is emphasized. The image processor 100 according to the embodiment can suppress the deterioration of image quality by the interpolation between display areas so as to smoothen the border.

When the texture, which is the high frequency component, is emphasized in an area including a large movement, flickering in the area is increased. As a result, the image quality of the moving image deteriorates. The image processor 100 according to the embodiment adjusts the image quality by using the image quality adjustment coefficient so as to reduce the emphasis level in the area including a large movement when the high image quality processing is performed for improving the image quality of the high frequency component. As a result, flickering can be suppressed.

The embodiments that have been described are presented by way of example only and are not intended to limit the scope of the invention. The embodiments described herein may be embodied in a variety of other forms. Furthermore, various omissions, substitutions and changes of the embodiment described herein may be made without departing from the spirit of the invention. The embodiments can be carried out in any combination of them as long as they have no discrepancy among them. The embodiments and their modifications fall within the scope and spirit of the invention and are covered by the accompanying claims and their equivalents.

Each function of the image processor described in the embodiments may be included in a camera and a television receiver, etc., as their components or may be achieved by a computer, such as a personal computer and a work station, executing a preliminarily prepared image processing program.

The image processing program executed by the computer can be distributed through a network such as the Internet. The image processing program can be recorded in a computer readable recording medium such as a hard disk, a flexible disk (FD), a compact disc read only memory (CD-ROM), a magnetooptic (MO) disk, or a digital versatile disc (DVD), and read from the recording medium and executed by the computer.

Moreover, the various modules of the systems described herein can be implemented as software applications, hardware and/or software modules, or components on one or more computers, such as servers. While the various modules are illustrated separately, they may share some or all of the same underlying logic or code.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An image processor comprising:
an image reducer configured to generate reduced input image information obtained by reducing input image information indicating input image information with a predetermined reduction ratio;
a moving amount calculator configured to calculate a moving amount in a unit of a predetermined first display area based on the reduced input image information and reduced previous image information obtained by reducing image information input prior to the input image information with the predetermined reduction ratio;
a calculator configured to calculate a moving amount in a unit of a second display area of the input image information by magnifying the moving amount in the unit of a predetermined first display area calculated by the moving amount calculator with a first magnification ratio that is an inverse of the predetermined reduction ratio, and calculate an adjustment level in the unit of the second display area based on the moving amount in the unit of the second display area, the adjustment level indicating a level of high frequency component image information to be blended on the input image information; and
a blending module configured to blend the high frequency component image information on the input image information in accordance with the adjustment level calculated by the calculator.

2. The image processor of claim 1, wherein the calculator is configured to calculate the adjustment level in a unit of a display block having a smaller display size than the second display area based on the adjustment level of the second display area selected and the adjustment level of the second display area adjacent to the selected second display area, and
the blending module is configured to blend the high frequency component image information on the input image information in accordance with the adjustment level calculated by the calculator in the unit of the display block.

3. The image processor of claim 1, further comprising:
a characteristic amount calculator configured to calculate, for each pixel included in the input image information, a characteristic amount indicating a change in a pixel value in a predetermined display area including the pixel; and
a generator configured to calculate a weight relating to a high frequency component for each pixel included in the input image information based on the calculated characteristic amount and a random variable based on a probability distribution indicating a distribution of relative values of a characteristic amount of each pixel included in a high frequency component of learning image information with respect to a characteristic amount of each pixel included in the learning image information, to weigh a predetermined image pattern indicating a pattern of a change in a pixel value with the weight, and to generate the high frequency component image information indicating the high frequency component of the input image information.

4. The image processor of claim 3, further comprising an image magnifier configured to generate magnified input image information by magnifying the input image information with a second magnification ratio, wherein
the generator is configured to calculate a weight relating to a high frequency component for each pixel included in the magnified input image information based on the random variable based on the probability distribution and the characteristic amount of each pixel included in the magnified input image information calculated based on the second magnification ratio, to weigh a predetermined image pattern indicating a pattern of a change in a pixel value with the weight, and to generates the high frequency component image information indicating the high frequency component of the magnified input image information, and
the calculator is configured to calculate a moving amount in a unit of a magnified display area obtained by magnifying the moving amount in the unit of the second display area calculated by the moving amount calculator with the first magnification ratio and the second magnification ratio, to calculate the adjustment level in the unit of the magnified display area based on the moving amount in the unit of the magnified display area, and to calculate the adjustment level in a unit of a display block having a smaller display size than the magnified display area based on the adjustment level of a display area selected and the adjustment level of a display area adjacent to the selected display area.

5. An image processing method comprising:
generating, by an image reducer, reduced input image information obtained by reducing input image information indicating input image information with a predetermined reduction ratio;
calculating, by a moving amount calculator, a moving amount in a unit of a predetermined first display area based on the reduced input image information and reduced previous image information obtained by reducing image information input prior to the input image information with the predetermined reduction ratio;
calculating, by a calculator, a moving amount in a unit of a second display area of the input image information by magnifying the moving amount in the unit of a predetermined first display area calculated by the moving amount calculator with a first magnification ratio that is an inverse of the predetermined reduction ratio, and calculate an adjustment level in the unit of the second display area based on the moving amount in the unit of the second display area, the adjustment level indicating a level of high frequency component image information to be blended on the input image information; and
superimposing, by a blending module, the high frequency component image information on the input image information in accordance with the adjustment level calculated by the calculator.
